(19) United States
(12) Patent Application Publication
(10) Pub. No.: US 2023/0281873 A1
(43) Pub. Date: Sep. 7, 2023

(54) Method for calibrating a portable reference sensor system, portable reference sensor system and use of the portable reference sensor system

(71) Applicant: AVL Software and Functions GmbH, Regensburg (DE)

(72) Inventors: Armin ENGSTLE, Regensburg (DE); Diego TURRADO BLANCO, Regensburg (DE)

(21) Appl. No.: 18/114,428

(22) Filed: Feb. 27, 2023

(30) Foreign Application Priority Data
Mar. 2, 2022 (DE) 10 2022 104 880.2

(51) Int. Cl. G06T 7/80; G06T 7/70; G01S 17/89

(52) U.S. Cl. CPC G06T 7/80; G06T 7/70; G01S 17/89; G06T 2207/30252

(57) ABSTRACT

Method for calibrating a portable reference sensor system with optical sensors and at least one position sensor, comprising the method steps of
a) calibrating the optical sensors of the reference sensor system to a predetermined reference coordinate system by determining a rotation matrix and/or translation matrix of each sensor so that a coordinate system of each sensor is calibrated to the reference coordinate system, wherein the respective rotation matrices and/or translation matrices are determined by detecting external calibration objects;
b) calibrating the position sensor to the reference coordinate system by detecting position markers, thereby performing a calibration of a coordinate system of the position sensor to a vehicle coordinate system by determining a rotation matrix and/or translation matrix.

### CROSS-REFERENCE TO RELATED APPLICATIONS

This application claims priority to German Application No. 10 2022 104 880.2, filed Mar. 2, 2022 and entitled “Verfahren zur Kalibrierung eines portablen Referenzsensorsystems, portables Referenzsensorsystem and Verwendung des portablen Referenzsensorsystems,” the entire disclosure of which is hereby incorporated by reference for all proper purposes.

### DESCRIPTION

The invention relates to a method for calibrating a portable reference sensor system with optical sensors and at least one position sensor. The invention further relates to a calibrated reference sensor system and the use of the calibrated reference sensor system.

The statistical evaluation of large amounts of representative real driving data for evaluating the performance of driver assistance system (ADAS) sensors and their algorithms becomes all the more decisive the higher the degree of automation (SAE level 0 to 5) of a vehicle. In this context, the objective comparison of sensor signals against an absolute reference is the only way to realise a cost-efficient and reliable sensor development and validation. Manufacturer-independent, standardised reference sensor systems are nevertheless a basic prerequisite for the homologation/type approval of future automated vehicles, as the relevant certification authorities will always base their assessment on their own environmental image. US companies such as Waymo and Uber, which see the technological step towards autonomous driving as a crucial part of their business model, consistently pursue the approach of data-driven development for the continuous improvement and optimisation of their products. Every further development, every new iteration of the products is constantly tested against the existing database and continuously optimised on the basis of the analysis results generated.

Crucial to the autonomous driving of vehicles are the vehicle sensors or the vehicle sensor system, which is capable of recording, understanding and reconstructing the static and dynamic environment of a vehicle. Each vehicle sensor of the vehicle sensor system uses its own coordinate system for this purpose, in which at least a section of the environment in the respective detection range of the sensor is detected. In order to be able to reconstruct the entire vehicle environment and to establish a geometric relationship between the respective coordinate systems of the sensors, it is necessary that the relative positions between all sensors of the vehicle sensor system and the vehicle are determined and calibrated.

For the development, calibration and validation of vehicle sensor systems or of vehicles comprising a vehicle sensor system, the state of the art uses a portable reference sensor system that is uniform for all vehicles. First, a vehicle is equipped with the reference sensor system. In order to be able to compare the sensor signals of the vehicle sensor system with the sensor signals of the reference sensor system, it is necessary in the following step to calibrate the reference sensor system to the vehicle or to determine the position of the portable reference sensor system relative to the vehicle. In the current state of the art, an external calibration device is used for this purpose, for example a motion capture system. The disadvantage of calibration by means of an external calibration device is that calibration is tedious and time-consuming. Especially with large vehicle fleets, which are necessary to generate the required amount of sensor data during driving in different vehicle environments (climatic conditions, weather, road conditions, traffic conditions, etc.), the management of a large-scale measurement series is particularly difficult. Especially the portable reference sensor system and the external calibration device are the limiting resources. If all sensors of the vehicle sensor system and all sensors of the reference sensor system are calibrated to each other or the respective positions to each other are known, the respective sensor data can be recorded and compared with each other.

If the reference sensor system is dismantled from the vehicle and re-mounted on the vehicle at a later time, the reference sensor system must also be calibrated again on the vehicle by means of the external calibration device in order to be able to maintain the required measurement tolerances in the order of millimetres with regard to a displacement or tenths of a degree with regard to a rotation. In practice, this means that this vehicle must be brought to the external calibration device again in order to calibrate the reference sensor system to the vehicle. This makes the calibration procedure even more time-consuming and expensive. A further disadvantage is that in order to calibrate the reference sensor system to the vehicle by means of the external calibration device, the vehicle must be equipped with the reference sensor system, so that this reference sensor system is at the same time not available elsewhere, for example for the acquisition of sensor data during driving.

It is therefore the task of the present invention to provide a method which overcomes the disadvantages of the method for determining the position of the portable reference sensor system compared to a vehicle in the prior art.

This task is solved by a method having the features of claim 1. Advantageous embodiments result from the subclaims.

The core idea of the invention is a method for calibrating a portable reference sensor system with optical sensors and at least one position sensor, comprising the method steps:
a) calibrating the optical sensors of the reference sensor system to a predetermined reference coordinate system by determining a rotation matrix and/or translation matrix of each sensor so that a coordinate system of each sensor is calibrated to the reference coordinate system, wherein the respective rotation matrices and/or translation matrices are determined by detecting external calibration objects;
b) calibrating the position sensor to the reference coordinate system by detecting position markers, thereby performing a calibration of a coordinate system of the position sensor to a vehicle coordinate system by determining a rotation matrix and/or translation matrix.

The optical sensors may be cameras and a plurality of LIDAR sensors. Preferably, the at least one position sensor is a dGPS or GNSS. It is particularly preferred that the at least one position sensor is part of a positioning system.

According to a preferred embodiment, the reference coordinate system of the reference sensor system is formed by a central lidar sensor. This means that all other sensors are calibrated to the reference coordinate system of the central lidar sensor.

The vehicle has its own coordinate system, the zero point of which is usually defined in the middle of the rear axle of the vehicle. The coordinate system of the vehicle is usually oriented in such a way that the three axes are oriented in a forward direction, in an elevation direction and in a lateral direction, each of which is orthogonal to the other.

Usually, the three axes of the reference sensor system are directed in a forward direction, in an elevation direction and in a lateral direction of the reference sensor system. In order to determine the position of the reference sensor system relative to the vehicle, it is particularly necessary to determine a displacement or translation (for example by means of a vector) of the zero point of the coordinate system of the reference sensor system relative to the zero point of the coordinate system of the vehicle, in particular to the nearest millimetre. In addition, it is necessary to determine a rotation of the reference coordinate system of the reference sensor system to the coordinate system of the vehicle. Ideally, the two coordinate systems have no rotation with respect to each other, but small deviations are possible, and it is necessary to determine deviations in the order of one tenth of a degree. A deviation between the reference coordinate system and the vehicle coordinate system in terms of an angular error is the critical error to consider, as this error scales with distance. An error of 1° between the reference coordinate system and the vehicle coordinate system means a lateral deviation of 1.75 metres at a distance of 100 metres.

As a requirement, a maximum angular error of no more than 0.2° is therefore considered acceptable.

After carrying out the method for calibrating the portable reference sensor system according to the invention, the reference sensor system can be transported and can now be used on any vehicle independently of the vehicle used during the method, without recalibration to the vehicle now in use. This makes it possible that only the portable reference sensor system has to be brought to the respective place of use without having to rely on a calibration hall or an external calibration. This will be referred to in detail later in the description.

Preferably, the external calibration objects can have a pattern or calibration pattern, for example a chessboard pattern or the like. Preferably, the external calibration objects are arranged in a fixed location, for example within a hall or calibration hall.

According to a preferred embodiment, a calibration pattern of the calibration object is defined. In particular, this means that information about the geometry of the calibration pattern is available or can be retrieved. Furthermore, dimensions such as lengths and angles of the calibration pattern or coordinates of distinctive points of the calibration pattern are known in the coordinate system of the calibration object and are used as information for the procedure. Preferably, the calibration pattern, in particular the distinctive points, is particularly easy to recognise by the reference sensor system. This is achieved, for example, by high colour contrasts and sharp colour edges.

Preferably, the calibration pattern is a simple or repeating pattern. Further preferred is the calibration pattern, a chessboard pattern or a dot pattern. In addition, any other pattern that is particularly suitable for the process may be used.

According to a particularly preferred embodiment, it is provided that in the step of calibrating the optical sensors, the reference sensor system is moved relative to the calibration objects by translational movements and/or rotational movements, so that the calibration objects can be detected by the optical sensors. The optical sensors are particularly preferred cameras.

For easier relative movement, it may preferably be provided that the reference sensor system is not mounted on the vehicle, but is arranged on a table, for example, and the table with the reference sensor system is moved relative to the calibration objects.

According to a further preferred embodiment, it may be provided that for each detected calibration object a respective normal vector of the calibration object is generated, whereby the respective rotation matrix and/or translation matrix is generated.

The respective generated rotation matrix and/or translation matrix calibrates the respective sensor with respect to the reference coordinate system, which is specified, for example, by the central lidar sensor.

This allows all sensors of the reference sensor system to be calibrated to the reference coordinate system by determining the corresponding rotation matrix and/or translation matrix. Preferably, the sensor that specifies the reference coordinate system is not calibrated to itself, since it specifies the reference coordinate system.

According to a further embodiment, it is provided that prior to process step a) the optical sensors, which are given by cameras, are calibrated in such a way that distortion effects of the respective lenses or camera lenses are eliminated.

Particularly preferably, the specific focal length of the respective camera lens is determined by means of a calibration routine of the reference sensor system, particularly preferably taking into account the manufacturing tolerances. The specific focal length is taken into account when generating a camera image.

According to a further preferred embodiment, it can be provided that after the calibration of the optical sensors and before the calibration of the position sensor, the reference sensor system is mounted on a vehicle.

According to the invention, it is envisaged that a reference to the vehicle coordinate system is provided, so that if the reference sensor system were not yet mounted on the vehicle, it must be set in relation to the vehicle.

If the reference sensor system were already mounted on the vehicle in process step a), the mounting step could be omitted.

According to the invention, the calibration of the position sensor to the reference coordinate system is performed by detecting position markers, whereby a calibration of a coordinate system of the position sensor to a vehicle coordinate system is performed by determining a rotation matrix and/or translation matrix.

According to a particularly preferred embodiment, it may be provided that during the calibration of the position sensor, position markers are detected on the calibration objects and on a rear axle of the vehicle, and wherein the position of the calibration objects to the reference sensor system is determined, whereby the position of the calibration objects to the rear axle is determined, whereby the rotation matrix and/or translation matrix of the reference sensor system to the vehicle coordinate system is determined.

The calibration of the position sensor or positioning system, for example a GNSS system, to the reference coordinate system, for example given by the central LI DAR, is the most difficult part of the calibration routine according to the invention, since a direct optical measurement is not available.

The multi-stage calibration process described below is realised in a calibration hall via a diversion of the extrinsic reference coordinate system to vehicle coordinate system calibration, which is why the reference sensor system for this calibration step is mounted on a vehicle.

Particularly preferably, the position markers can be detected by means of an external camera system. For example, the external camera system can be mounted or arranged in the hall. Particularly preferably, the external camera system is a 3D camera system.

Position markers, which are precisely detected by the external camera system, are mounted on the rear axle or wheel hub of the vehicle, whereby the rear axle or wheel hub corresponds to the vehicle coordinate system, as well as on the calibration objects. The central LI DAR detects the relative position of the central LIDAR to the calibration object. The external camera system determines the position of the calibration objects in relation to the vehicle coordinate system. This makes it possible to perform the rotation matrix and/or translation matrix for the extrinsic calibration reference sensor system to vehicle.

With the help of an internal calibration routine of the positioning system, the rotation matrix between the positioning system and the rear axle, i.e. the vehicle coordinate system, is determined.

Preferably, a movement pattern specified by the manufacturer of the positioning system is traced in the open air. After this movement pattern has been traced several times, the angular offset determined in this way can be given as 0.05-0.1° according to the manufacturer's specifications. The translation matrix between the positioning system and the vehicle coordinate system is determined by the external camera system or a marker placed on a housing of the positioning system.

Further, the underlying problem is solved by the calibrated reference sensor system, which is calibrated by means of the method according to the invention.

The underlying problem is further solved by using the calibrated reference sensor system with any vehicle. By any vehicle is meant any vehicle other than the vehicle used according to the method.

Although the extrinsic calibration of the reference sensor system to the vehicle has already been explained, a special challenge arises for the use of the calibrated reference sensor system for any vehicle. Since a calibration test bench or calibration hall is not available everywhere, the extrinsic calibration of the reference sensor system to the (arbitrary) vehicle must be presented in other ways to enable the change of the reference sensor system from one vehicle to another, even locally without a hall.

For this purpose, the described calibration procedure is carried out in the opposite direction to the calibration procedure of the reference sensor system.

Since the orientation of the positioning system or the corresponding rotation matrix and translation matrix to the reference coordinate system, for example the central lidar, is known, the rotation matrix of the positioning system to the vehicle rear axle or the reference coordinate system of the vehicle now being used is determined with the aid of the calibration routine of the positioning system after each vehicle change.

Due to the comparatively low error influence of the translation matrix, the three-dimensional distance of the positioning system to the rear axle of any vehicle can be measured, for example with the help of a pocket rule or a contact measuring arm.

By formally combining the known extrinsic calibration of the reference sensor system, i.e. positioning system to reference coordinate system, and the calibration of the positioning system to the rear axle, the extrinsic calibration of the reference coordinate system to the vehicle or rear axle can be calculated.

According to a particularly preferred embodiment, it may be provided that the calibrated reference sensor system is mounted on the arbitrary vehicle and wherein, after mounting the reference sensor system by means of the position sensor, a rotation matrix of the position sensor to a rear axle of the arbitrary vehicle is determined and the translation matrix of the position sensor to the rear axle of the arbitrary vehicle is measured.

As explained above, it is particularly advantageous to provide that the use of the reference sensor system is independent of external calibration objects and position markers.

In particular, it is possible to use the reference sensor system at any location without further devices, regardless of the present vehicle. With the help of the method, the portable reference sensor system can thus advantageously be attached and calibrated by one vehicle to another in a real vehicle environment, such as in urban traffic, without the vehicle having to be driven to an external calibration device with the reference sensor environment attached. Thus, time and money for position determination can be saved, the management of a test series can be simplified and resources of an external calibration device can be saved.

The task is further solved by a device. The device can be equipped with all the features already described above in the context of the method, either individually or in combination with one another, and vice versa.

According to the invention, a device is provided for carrying out a method for calibrating a portable reference sensor system, comprising the portable reference sensor system, which can be attached to a vehicle, the reference sensor system comprising optical sensors and at least one position sensor.

Accordingly, this device is capable of performing the method and use according to the invention.

According to a preferred embodiment, the portable reference sensor system is at least partially mountable on a roof of a vehicle. Preferably, the reference sensor system comprises a roof box which can be mounted on any commercially available vehicle roof. In particular, the reference sensor system can be detachably connected to the vehicle, preferably plugged, screwed, clamped, sucked or the like to the vehicle. Preferably, the necessary infrastructure, for example for the power supply and data transfer to operate the reference sensor system, can be accommodated in the boot of the vehicle.

This has the advantage that the reference sensor system can be quickly converted from one vehicle to another. Further, when positioned on the roof of the vehicle, it is possible for the reference sensor system to generate a holistic 360° reference data set of the vehicle environment.

Preferably, the reference sensor system is the AVL Dynamic Ground Truth (DGT) system.

According to a preferred embodiment, the portable reference sensor system comprises optical sensors and at least one position sensor or positioning system. Further preferably, the reference sensor system comprises at least one arithmetic unit. The reference sensor system further preferably comprises a memory unit.

The optical sensors are preferably at least one selected from the group comprising lidar sensors, radar sensors, cameras, ultrasonic sensors, infrared sensors, and any combination thereof.

The position sensor may be a receiver of signals from a navigation satellite system.

Preferably, acquired sensor data from the reference sensor system can be processed by the arithmetic unit and stored in the memory unit.

The coverage of all sensor units is preferably optimised for a maximum coverage of the vehicle environment in 360° around the vehicle in order to ensure the usability of the reference data for as many Advanced Driver Assistance System (ADAS) functions as possible.

According to a preferred embodiment, the vehicle comprises a vehicle sensor system, whereby acquired sensor data of the vehicle sensor system can be compared with acquired environment data of the reference sensor system of the vehicle environment. The vehicle sensor system is preferably at least part of a driver assistance system (ADAS).

In particular, the vehicle sensor system is calibrated to the vehicle so that dynamic and static objects can be detected, classified and positioned in relation to the vehicle. In particular, the comparison of sensor data is possible because the third position of the reference sensor system relative to the vehicle can be determined by the device, so that dynamic and static objects can also be detected, classified and positioned in relation to the vehicle.

All features disclosed in the application documents may be disclosed in a corresponding manner with appropriate wording for all categories of claims.

Further objectives, advantages and usefulness of the present invention, are explained with reference to the accompanying drawings and the following description.

Hereby show:

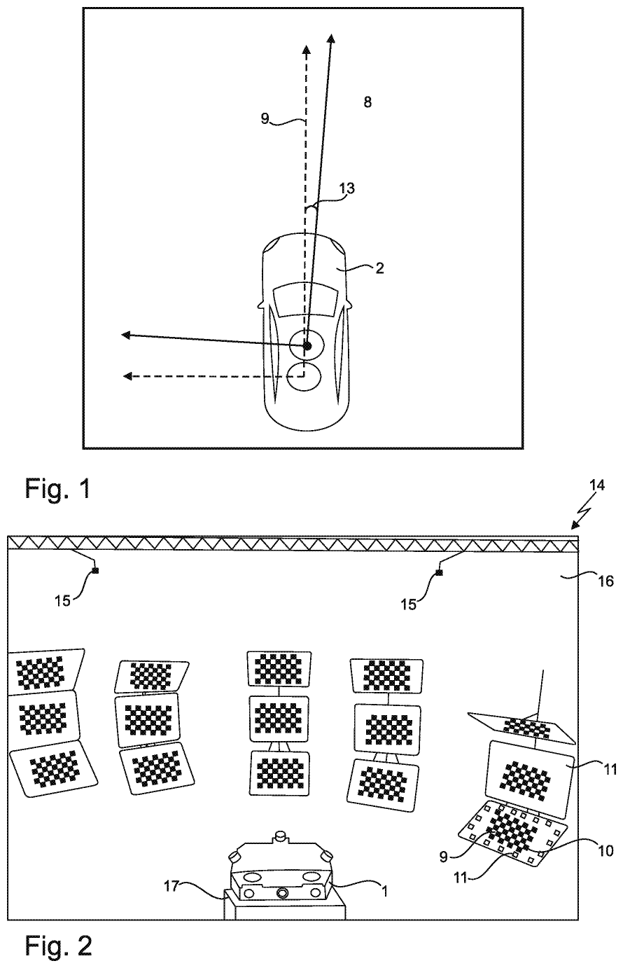

FIG. 1 the basic requirements for the reference sensor system;

FIG. 2 a representation of the first process steps;

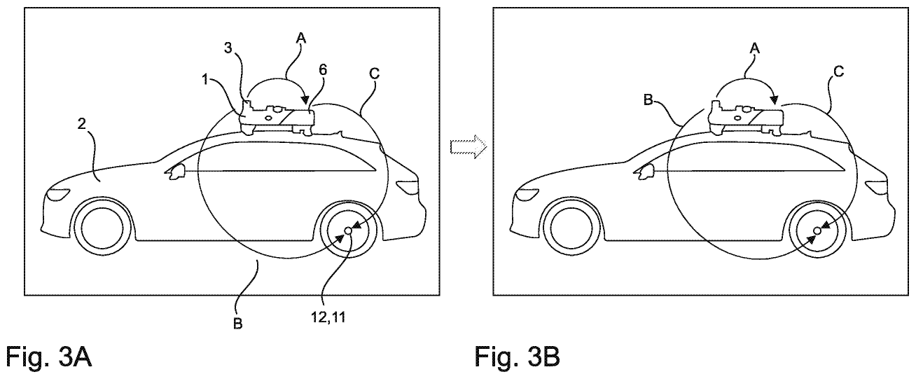

FIG. 3A a representation of further process steps;

FIG. 3B a use or a method for using the reference sensor system;

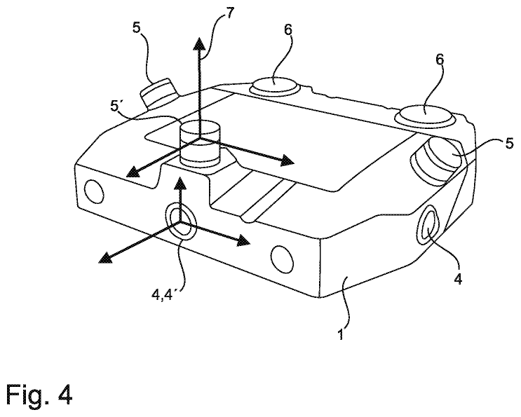

FIG. 4 a reference sensor system.

In the figures, the same components are to be understood with the corresponding reference signs. For the sake of clarity, some components may not have a reference sign in some figures, but have been designated elsewhere.

The main application of a reference sensor system 1 is to generate an independent, highly accurate reference image of an environment during the development and validation phase of ADAS/AD sensors and systems, against which the system under test (SUT) or the vehicle sensor technology can be tested.

In order to make this possible, the data of the vehicle sensor system and the reference sensor system must on the one hand be recorded synchronously in terms of time and on the other hand be coordinated with each other in terms of the reference coordinate systems, a reference coordinate system 7 and a vehicle coordinate system 8.

An angular offset 13 of, for example, only 1° between the vehicle coordinate system 8 and the reference coordinate system 7 of the reference sensor system 1, leads trigonometrically to a lateral positioning deviation of the detected object of approx. 1.75 metres at a distance of 100 metres, as can be seen in FIG. 1.

Accordingly, a maximum angular offset 13 of at most 0.2° is defined as acceptable as a requirement for the extrinsic calibration of the reference sensor system 1, which is associated with a positioning deviation of approximately 0.35 metres at a distance of 100 metres. Since the absolute translational calibration error does not scale with distance and a deviation of at most 0.05 metres can be achieved, this requirement is negligible.

In addition to the accuracy criterion, further functional requirements must be ensured, especially for the recording of the calibration data during the calibration process:
High degree of repeatability: As a plug-and-play reference system, the reference sensor system 1 must be calibrated at the end of production and all relevant functional checks must have been performed. The calibration/test routines used must be process-safe and repeatable;
Time-efficient performance of calibration data recording;
Automated generation of calibration and test reports.

To meet these requirements, the decision was made at an early stage of development to use a calibration test stand with defined external calibration objects 9. In contrast to online or self-calibration, the accuracy is more precise and verifiable due to the known calibration patterns 10 and the defined positions of the calibration objects 9. Preferably, a monitoring algorithm additionally monitors the quality of the sensor calibration in the field or during the fleet test.

The vehicle coordinate system 9 of the vehicle 1 preferably has its origin in the centre of a rear axle 12 of the vehicle 2. The axes of the vehicle coordinate system 9 are directed in such a way that these axes are directed in a forward direction, in a height direction and in a lateral direction, each of which is orthogonal to the other. The reference coordinate system 8 of the reference sensor system 1, which in this illustration has its origin in a fixed sensor, for example, the central lidar 5, are also shown in FIG. 1.

In order to be able to calibrate the reference coordinate system 8 and the vehicle coordinate system 9 to each other, it is first necessary to calibrate the reference sensor system 1.

According to the invention, it is provided that a method for calibrating a portable reference sensor system 1 with optical sensors 3 and at least one position sensor 6 is carried out, comprising the method steps:
a) Calibration of the optical sensors 3 of the reference sensor system 1 to a predetermined reference coordinate system 7 by determining a rotation matrix and/or translation matrix of each sensor 3, 6, so that a coordinate system of each sensor is calibrated to the reference coordinate system 7, the respective rotation matrices and/or translation matrices being determined by detecting external calibration objects 9;
b) Calibration of the position sensor 6 to the reference coordinate system 7 by detecting position markers 11, whereby a calibration of a coordinate system of the position sensor 6 to a vehicle coordinate system 8 is carried out by determining a rotation matrix and/or translation matrix.

The method step a) is exemplarily shown in FIG. 2, whereby the reference sensor system 1 is arranged in a calibration hall 16, preferably on a mobile table 17. Furthermore, a plurality of external calibration objects 9 with calibration patterns 10 are arranged in the calibration hall 16.

According to a particularly preferred embodiment, it is provided that during the step of calibrating the optical sensors 3, the reference sensor system 1 is moved relative to the calibration objects by translational movements and/or rotational movements, so that the calibration objects 9 can be detected by the optical sensors 3. The optical sensors 3 are particularly preferred cameras 4. A rotational movement and/or translational movement of the reference sensor system 1 can be performed by moving the table 17 accordingly.

For easier relative movement, it may also be preferable for the reference sensor system 1 not to be mounted on the vehicle 2, but to be arranged on a table 17, for example, and for the table 17 with the reference sensor system 1 to be moved relative to the calibration objects 9.

According to a further preferred embodiment, it may be provided that for each detected calibration object 9 a respective normal vector of the calibration object 9 is generated, whereby the respective rotation matrix and/or translation matrix is generated.

The respective generated rotation matrix and/or translation matrix calibrates the respective optical sensor 3 with respect to the reference coordinate system 7, which is indicated, for example, by the central lidar sensor 5′.

In this way, all optical sensors 3 of the reference sensor system 1 can be calibrated to the reference coordinate system 7 by determining the corresponding rotation matrix and/or translation matrix. Preferably, the sensor that specifies the reference coordinate system 7 is not calibrated to itself, since it specifies the reference coordinate system 7.

All optical sensors 3 of the reference sensor system 1 are now calibrated to the reference coordinate system.

In step b) the position sensor 6 or the positioning system 6 is calibrated to the reference coordinate system 7. However, since no optical calibration is available for this, a multi-stage calibration is provided.

The multi-stage calibration process described below is implemented in a calibration hall 16 via a diversion from the extrinsic reference coordinate system 7 to vehicle coordinate system calibration, which is why the reference sensor system 1 is mounted on the vehicle 2 for this calibration step.

Particularly preferably, the position markers 11 can be detected by means of an external camera system 14 comprising several external cameras 15. For example, the external camera system 14 may be mounted or arranged in the hall 16. Particularly preferably, the external camera system 14 is a 3D camera system.

Position markers 11, which are precisely detected by the external camera system 14, are mounted on the rear axle 12 or the wheel hub of the vehicle 2, whereby the rear axle 12 or the wheel hub corresponds to the vehicle coordinate system 8, as well as on the calibration objects 9. The central lidar 5′ detects the relative position of the central lidar 5′ to the calibration object 9. The external camera system 14 determines the position of the calibration objects 9 in relation to the vehicle coordinate system 8. This makes it possible to perform the rotation matrix and/or translation matrix for the extrinsic calibration reference sensor system 1 to vehicle 2.

With the help of an internal calibration routine of the positioning system 6, the rotation matrix between the positioning system 6 and the rear axle 12, i.e. the vehicle coordinate system 8, is determined.

FIG. 3A illustrates the described procedure for calibrating the reference sensor system 2.

Arrow A shows the procedure step b), which can only be carried out by a diversion, represented by arrows B and C.

Arrow B corresponds to the recognition of the position markers 11 on the rear axle 12, so that the position of the rear axle 12 and accordingly the vehicle coordinate system 8 to the reference coordinate system is known.

Arrow C corresponds to the step of the procedure with an internal calibration routine of the positioning system 6, whereby the rotation matrix between the positioning system 6 and the rear axle 12, i.e. the vehicle coordinate system 8, is determined.

This calibrates the reference sensor system 1, i.e. all sensors 3, 6 are calibrated to the reference coordinate system 7.

FIG. 3B shows the use of the calibrated reference sensor system 1, where the calibrated reference sensor system 1 is mounted on any vehicle 2. Due to the fact that the vehicle coordinate system 8 has changed, a calibration of the vehicle coordinate system 8 to the reference coordinate system 7 is necessary.

According to FIG. 3B, arrow A is now known because the reference sensor system 1 is calibrated. Furthermore, arrow C is known, due to the internal calibration routine of the positioning system 6, whereby the rotation matrix is known. The translation matrix can be determined by a simple measurement of the three-dimensional distance between the positioning system 6 and the rear axis 12.

By knowing arrow A and arrow C, it is possible to infer the arrow B that is now still required, so that calibration in the calibration hall 16 can be omitted.

FIG. 4 shows a perspective view of the reference sensor system 1.

The reference sensor system comprises several optical sensors 3, which on the one hand are designed as LI DAR sensors 5, 5′ and cameras 4. Furthermore, a positioning system 6 with at least one position sensor 6 is shown. The LI DAR 5′, also referred to as central LI DAR 5′, defines the reference coordinate system 7. The other LI DAR sensors 5 are referred to as lateral LIDAR sensors.

Each sensor 4, 5 has its own coordinate system which is calibrated to the reference coordinate system. The coordinate system of the front or central camera 4′ is shown as an example.

It is understood that the embodiments explained above are only a first embodiment of the device according to the invention. In this respect, the embodiment of the invention is not limited to these embodiments.

All features disclosed in the application documents are claimed to be inventive if they are individually or in combination new compared to the prior art.

### LIST OF REFERENCE SIGNS

1 Reference sensor system
2 Vehicle
3 Optical sensor
4 Camera
5 LIDAR
5′ central LI DAR
6 Positioning system, position sensor
7 Reference coordinate system
8 Vehicle coordinate system
9 External calibration object
10 Calibration pattern
11 Position marker
12 Rear axle
13 Angle, angular offset
14 External camera system
15 External camera
16 Calibration hall
17 Table

1. A method of calibrating a portable reference sensor system having optical sensors and at least one position sensor, comprising the steps of
a) calibrating the optical sensors of the reference sensor system to a predetermined reference coordinate system by determining a rotation matrix and/or translation matrix of each sensor so that a coordinate system of each sensor is calibrated to the reference coordinate system, wherein the respective rotation matrices and/or translation matrices are determined by detecting external calibration objects;
b) calibrating the position sensor to the reference coordinate system by detecting position markers, whereby a calibration of a coordinate system of the position sensor to a vehicle coordinate system is performed by determining a rotation matrix and/or translation matrix.

2. The method according to claim 1, wherein in the step of calibrating the optical sensors, the reference sensor system is moved relative to the calibration objects by translational movements and/or rotational movements so that the calibration objects can be detected by the optical sensors.

3. The method according to claim 2, wherein for each detected calibration object a respective normal vector of the calibration object is generated, thereby generating the respective rotation matrix and/or translation matrix.

4. The method according to claim 1, wherein after the calibration of the optical sensors and before the calibration of the position sensor, the reference sensor system is mounted on a vehicle.

5. The method according to claim 4, wherein in the step of calibrating the position sensor, position markers are detected on the calibration objects and a rear axle of the vehicle, and wherein the position of the calibration objects to the reference sensor system is determined, thereby determining the position of the calibration objects to the rear axle, thereby determining the rotation matrix and/or translation matrix of the reference sensor system to the vehicle coordinate system.

6. A calibrated reference sensor system which is calibrated by means of a method according to claim 1.

7. Usage of a calibrated reference sensor system according to claim 6 with an arbitrary vehicle.

8. Usage according to claim 7, wherein the calibrated reference sensor system is mounted on the arbitrary vehicle and wherein after mounting the reference sensor system by means of the position sensor a rotation matrix of the position sensor to a rear axle of the arbitrary vehicle is determined and the translation matrix of the position sensor to the rear axle of the arbitrary vehicle is measured.

9. Usage according to claim 7, wherein the usage of the reference position sensor system is independent of external calibration objects and position markers.
